(19) United States
(12) Patent Application Publication
(10) Pub. No.: US 2020/0205598 A1
(43) Pub. Date: Jul. 2, 2020

(54) Electric Pressure Cooker Cover

(71) Applicant: Foshan Shunde Aide Industry Co., Ltd, Guangdong (CN)

(72) Inventor: Zhigang HE, Guangdong (CN)

(73) Assignee: Foshan Shunde Aide Industry Co., Ltd, Guangdong (CN)

(21) Appl. No.: 16/237,781

(22) Filed: Jan. 2, 2019

(51) Int. Cl. A47J 27/09; A47J 45/06

(52) U.S. Cl. CPC A47J 27/09; A47J 2202/00; A47J 45/068

(57) ABSTRACT

The invention discloses an electric pressure cooker cover, comprising a steel cover, an exhaust valve component and a cover handle arranged on the steel cover, characterized in that, the electric pressure cooker cover is provided with a thermometer and pressure gauge component which is embedded in the cover handle, the thermometer and pressure gauge component comprises a dial arranged on the cover handle and a probe arranged under the dial, and the probe penetrates through the steel cover to extend into the cooker. By installing the thermometer and pressure gauge, the electric pressure cooker cover enables the user to directly and conveniently observe the temperature and pressure in the pressure cooker.

### TECHNICAL FIELD

The invention relates to the technical field of pressure cooker, in particular to an electric pressure cooker cover.

### BACKGROUND ART

The existing electric pressure cooker will not control the pressure by continuous exhausting in use, and thus the user can't visually know the pressure in the cooker in use. If the exhaust valve is toggled or the cover is opened forcibly in the state that there is still a higher pressure in the cooker, the food in the cooker will spurt out to cause a danger.

### SUMMARY OF THE INVENTION

Aiming at the problems existing in the prior art, the invention aims to provide an electric pressure cooker cover.

For the above purpose, the invention adopts the following technical schemes.

An electric pressure cooker cover, comprising a steel cover, an exhaust valve component and a cover handle arranged on the steel cover, characterized in that, the electric pressure cooker cover is provided with a thermometer and pressure gauge component which is embedded in the cover handle, the thermometer and pressure gauge component comprises a dial arranged on the cover handle and a probe arranged under the dial, and the probe penetrates through the steel cover to extend into the cooker.

As the further explanation of the above scheme, a bimetallic twisted ring is arranged in the probe, the upper end of the bimetallic twisted ring is connected with a pointer pivot, the upper end is welded with an elastic sheet base, and the elastic sheet base is in close contact with the inner wall of the probe.

As the further explanation of the above scheme, the pointer pivot is provided with a pointer, the pointer is arranged on the dial, and the bimetallic twisted ring swells and twists to drive the pointer to swing by the heat transmission of the elastic sheet base.

As the further explanation of the above scheme, corresponding pressure values are marked between 105° C.˜120° C. in the dial of the thermometer and pressure gauge.

As the further explanation of the above scheme, the exhaust valve component comprises an exhaust pipe and a gas valve thimble, the exhaust pipe penetrates through the electric pressure cooker cover, the gas valve thimble blocks the upper outlet of the exhaust pipe, and the gas valve thimble can move back and forth vertically.

As the further explanation of the above scheme, a floater component is arranged on the electric pressure cooker cover, the floater component comprises a floater, a floater valve seat and a slide bar component, the floater is arranged in the floater valve seat, the slide bar component of which one end is connected with the floater is arranged in the lock hole on the side of the electric pressure cooker cover, and the slide bar component extends out of the lock hole to lock the cover when the floater moves upwards.

The invention has the advantages that:

Compared with the prior art, the electric pressure cooker cover of the invention can directly and conveniently observe the temperature and pressure in the electric pressure cooker.

### BRIEF DESCRIPTION OF THE DRAWINGS

FIG. 1 shows the three-dimensional structural drawing of the electric pressure cooker cover provided by the invention;

FIG. 2 shows the top view of the electric pressure cooker cover provided by the invention;

FIG. 3 shows the section view of A-A in FIG. 2;

FIG. 4 shows the front view of thermometer of the electric pressure cooker cover provided by the invention;

FIG. 5 shows the section view of B-B in FIG. 4;

FIG. 6 shows the top view of the thermometer and pressure gauge of the electric pressure cooker cover with temperature and pressure display provided by the invention.

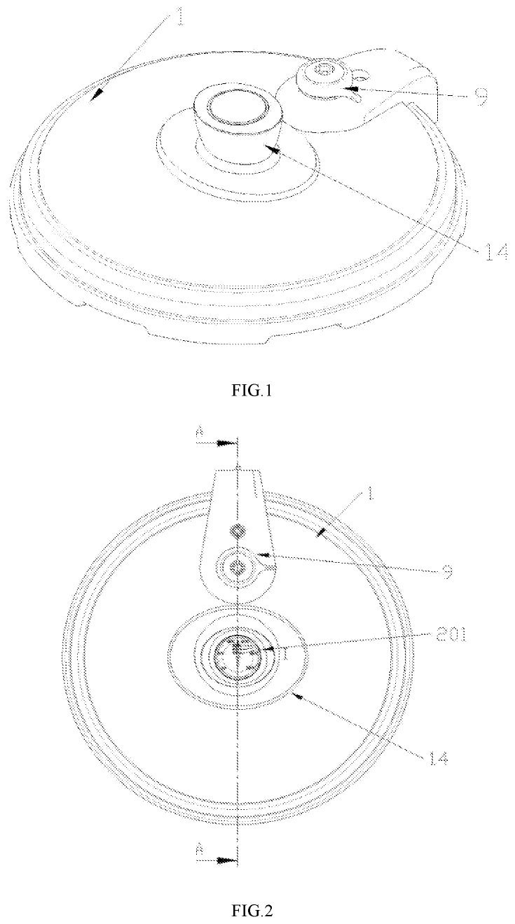

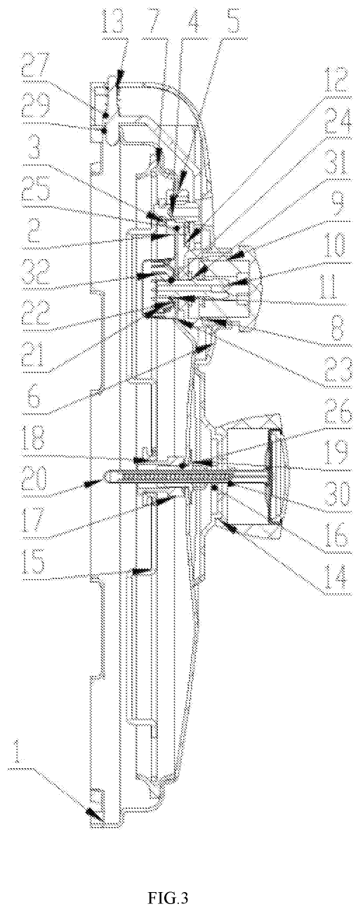

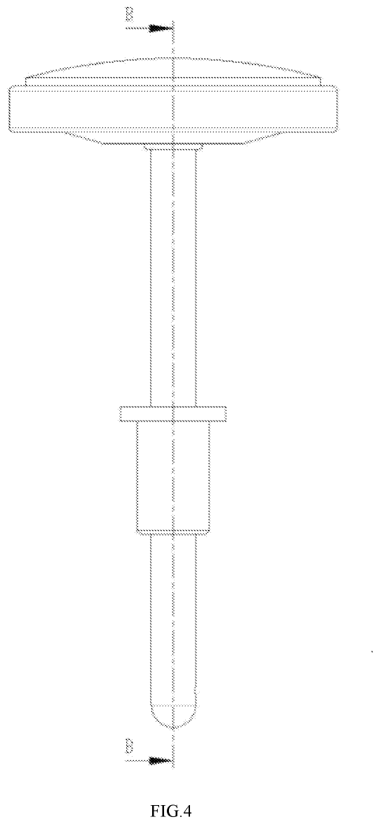

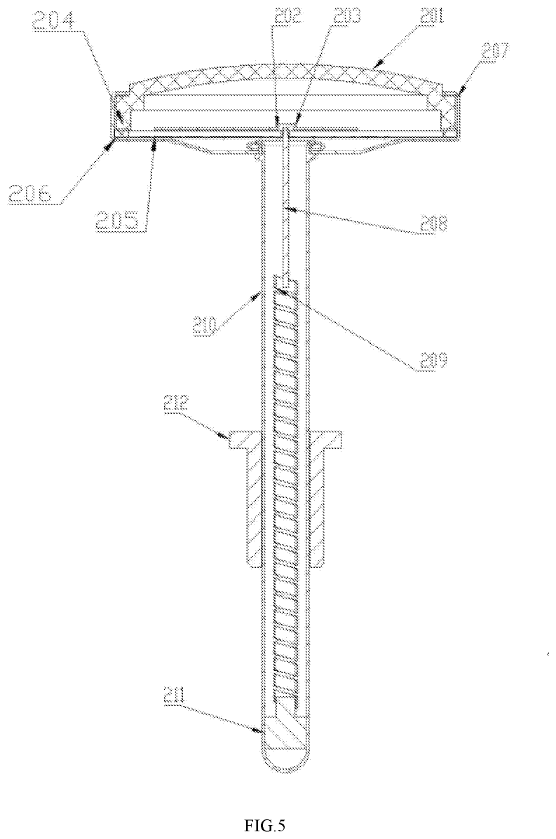

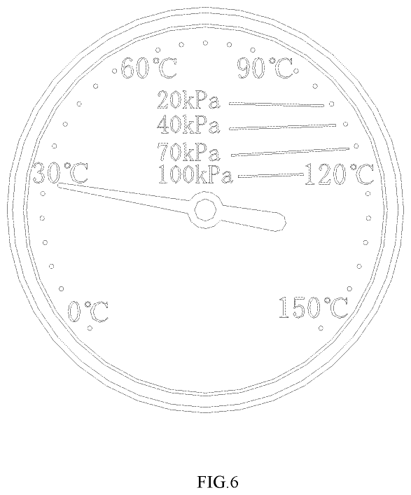

Notes of markers in the drawings:

1: Steel cover, 2: Floater valve seat, 3: Floater silica gel, 4: Floater, 5: Floater nut, 6: Gas valve seat, 7: Seal ring of cover, 8: Toggle bar of exhaust valve, 9: Gas valve body, 10: Gas valve thimble, 11: Exhaust pipe, 12: Pressing sheet of slider bar, 13: Slide bar component, 14: Cover handle, 15: Seal ring bracket, 16: Cover handle seat, 17: Fixing nut, 18: Seal ring bracket washer, 19: Handle fixing bracket, 20: Thermometer component, 21: Anti-blocking cap fixing support, 22: Exhaust pipe washer, 23: Anti-blocking cap, 24: Mouth-shaped seal ring, 25: Seal ring of floater valve, 26: Seal ring, 27: Push rod spring, 28: Countersunk tapping screw, 30: Pan head screw, 31: Flat washer, 32: Hex nut, 201: Gauge cover, 202: Pointer, 203: Pointer pivot sleeve, 204: Seal ring of thermometer, 205: Dial screen print, 206: Dial, 207: Dial seat, 208: Pointer pivot, 209: Bimetallic twisted ring, 210: Probe, 211: Elastic sheet base, 212: Fixed flange.

### DETAILED DESCRIPTION OF THE PREFERRED EMBODIMENT

In the descriptions of the invention, it shall be explained that for the nouns of locality, the terms indicating directions and positions such as “center”, “transverse”, “longitudinal”, “length”, “width”, “thickness”, “on”, “under”, “front”, “rear”, “left”, “right”, “vertical”, “horizontal”, “top”, “bottom”, “inside”, “outside”, “clockwise”, “counterclockwise”, etc. based on the drawings are only for convenience of explaining the invention and simplifying the descriptions, rather than indicating or implying that the indicated device or component must have the specific direction or must be structured and operated in the specific directions, and it can't be understood as limiting the specific protective scope of the invention.

Besides, the terms of “first” and “second” are only for the purpose of descriptions but can't be understood as indicating or implying the relative importance or implicating to specify the quantity of technical features. Thus, the features limited by “first” and “second” can indicate or implicate to comprise one or multiple features, and in the descriptions of the invention “at least” means one or more than one, unless otherwise specified.

In the invention, unless otherwise specified, the terms of “assemble”, “connect”, “connected” shall be understood in broad sense, for example, it can be fixedly connected, or detachably connected or integrally connected; it can be mechanically connected; it can be directly connected, or connected through an intermediate, and it can also be the interconnection of two elements. For the common technicians of this field, the specific meanings of the above terms in the invention can be understood according to the specific conditions.

In the invention, unless otherwise specified, the first feature is “above” or “under” the second feature can comprise the direct contact between the first and the second features, and can also comprise that the first feature and the second feature are in contact through another feature between them rather than direct contact. Besides, the first feature is “above”, “under” and “on” the second feature comprises that the first feature is directly and obliquely above the second feature, or only indicates that the level of the first feature is higher than the level of the second feature. The first feature is “above”, “under” and “below” the second feature comprises that the first feature is directly and obliquely below the second feature, or only indicates that the level of the first feature is lower than the level of the second feature.

The embodiments of the invention are further described in combination with the drawings of the specifications below, so that the technical schemes and the advantages of the invention can be clearer and more definite. The embodiments described below in reference to the drawings are exemplary and for the purpose of explaining the invention, and can't be understood as the limitations to the invention.

As shown in FIG. 1˜FIG. 6, an electric pressure cooker cover, comprising a steel cover, an exhaust valve component an exhaust valve component and a cover handle arranged on the steel cover, characterized in that, the electric pressure cooker cover is provided with a thermometer and pressure gauge component which is embedded in the cover handle, the thermometer and pressure gauge component comprises a dial arranged on the cover handle and a probe arranged under the dial, and the probe penetrates through the steel cover to extend into the cooker.

Wherein, the thermometer and pressure gauge component comprises a dial cover 201, a pointer 202, a pointer pivot sleeve 203, a seal ring 204 of thermometer and pressure gauge, dial screen print 205, a dial 206, a gauge seat 207, a pointer pivot 208, a bimetallic twisted ring 209, a probe 210, an elastic sheet base 211 and a fixed flange 212. The dial 206 is arranged on the cover 201 handle, the probe 210 is arranged under the dial, the probe penetrates through the steel cover 1 to extend into the cooker, and the fixed flange 212 is arranged on the probe for fixing the probe. The gauge cover is arranged outside the dial 206, the pointer 202 is arranged on the dial 206, the pointer is connected with the pointer pivot 208 through the pointer pivot sleeve 203, the pointer pivot 208 with the other end connected with the bimetallic twisted ring 209 is arranged in the probe 210. The probe 210 extends into the cooker through the hole on the steel cover 1, the bimetallic twisted ring is in the probe, one end of the bimetallic twisted ring is welded on the elastic sheet base 211, the elastic sheet base 211 is in close contact and riveted with the inner wall of the probe 210 for heat transmission. One end of the bimetallic twisted ring 209 is welded with the pointer pivot 208, and the pointer 202 is installed on the pointer pivot 208. The bimetallic twisted ring 209 will swell in size when it is heated, since it is made of bimetallic strip, the swelling rate of the external metal is greater than that of the internal metal, and the bimetallic twisted ring will twist under the uneven internal and external stresses to drive the pointer to swing. The higher the temperature is, the greater the swinging deviation angle will be. There is a dial in the pointer of the thermometer, and the temperature spots are marked corresponding to the position of the pointer.

Preferably, as shown in FIG. 6, since the temperature and pressure of saturated steam have certain correspondence with temperature under routine barometric pressure, the corresponding pressure values are marked between 105° C.˜120° C. in the dial of the temperature and pressure display gauge (according to the comparison table of temperature and pressure of saturated steam), so that the pressure in the electric pressure cooker can be visually known.

Further preferably, the exhaust valve component comprises an exhaust pipe 11 and a gas valve thimble 10 blocked at the upper outlet of the exhaust pipe, the exhaust pipe 11 penetrates through the cover to connect with the inter space of the electric pressure cooker in order to externally exhaust the steam inside the electric pressure cooker, the gas valve thimble 10 can move back and forth vertically, and on completion of heating the food and after observing the temperature and pressure display gauge, the exhaust pipe is opened by lifting the gas valve thimble to exhaust the internal gas to reduce the pressure.

Further preferably, a floater component is arranged on the electric pressure cooker cover, the floater component comprises a floater 4, a floater valve seat 2 and a slide bar component 13, and the floater 4t is arranged in the floater valve seat 2. The slide bar component 13 of which one end is connected with the floater 4 is arranged in the lock hole on the side of the electric pressure cooker cover, the floater moves upwards when there is a higher pressure in the electric pressure cooker, and at this moment, the slide bar component 13 can extend out of the lock hole to lock the cover, so as to avoid the user from rotating the cover under higher pressure in the electric pressure cooker.

Compared with the prior art, the electric pressure cooker cover provided by the embodiment has the following characteristics: By installing the thermometer and pressure gauge, the electric pressure cooker cover enables the user to directly and conveniently observe the temperature and pressure in the pressure cooker.

Through the above descriptions of structures and principles, the technicians of the technical field shall understand that the invention is not limited to the above embodiments, all the improvements and substitutes using the well-known knowledge of this field based on the invention are within the protective scope of the invention, and the protective scope of the invention shall be limited by the claims and the equivalents. The parts not covered in the embodiments are all the prior arts or well-known knowledge.

1. An electric pressure cooker cover with temperature and pressure display, comprising a steel cover, an exhaust valve component and a cover handle arranged on the steel cover, characterized in that, the electric pressure cooker cover is provided with a thermometer and pressure gauge component; the thermometer and pressure gauge component is embedded in the cover handle, the thermometer and pressure gauge component comprises a dial arranged on the cover handle and a probe arranged under the dial, and the probe penetrates through the steel cover to extend into the cooker.

2. An electric pressure cooker cover with temperature and pressure display according to claim 1, characterized in that, a bimetallic twisted ring is arranged in the probe, the upper end of the bimetallic twisted ring is connected with a pointer pivot, the lower end is welded with an elastic sheet base, and the elastic sheet base is in close contact with the inner wall of the probe.

3. An electric pressure cooker cover with temperature and pressure display according to claim 2, characterized in that, the pointer pivot is provided with a pointer, the pointer is arranged on the dial, and the bimetallic twisted ring swells and twists to drive the pointer to swing by the heat transmission of the elastic sheet base.

4. An electric pressure cooker cover with temperature and pressure display according to claim 1, characterized in that, corresponding pressure values are marked between 105° C.˜120° C. in the dial of the thermometer and pressure gauge.

5. An electric pressure cooker cover with temperature and pressure display according to claim 1, characterized in that, the exhaust valve component comprises an exhaust pipe and a gas valve thimble, the exhaust pipe penetrates through the electric pressure cooker cover, the gas valve thimble blocks the upper outlet of the exhaust pipe, and the gas valve thimble can move back and forth vertically.

6. An electric pressure cooker cover with temperature and pressure display according to claim 1, characterized in that, a floater component is arranged on the electric pressure cooker cover with temperature and pressure display, the floater component comprises a floater, a floater valve seat and a slide bar component, the floater is arranged in the floater valve seat, the slide bar component of which one end is connected with the floater is arranged in the lock hole on the side of the electric pressure cooker cover, and the slide bar component extends out of the lock hole to lock the cover when the floater moves upwards.
